(19) United States
(12) Patent Application Publication
(10) Pub. No.: US 2009/0216652 A1
(43) Pub. Date: Aug. 27, 2009

(54) POINT-OF-SALE ENHANCEMENT SYSTEM

(75) Inventors: John James Eggert, Dayton, OH (US); David Alan Watson, Dayton, OH (US)

Correspondence Address: THOMPSON HINE L.L.P.;Intellectual Property Group, P.O. BOX 8801, DAYTON, OH, 45401-8801, US

(73) Assignee: WEconnectIT, Dayton, OH (US)

(21) Appl. No.: 12/034,856

(22) Filed: Feb. 21, 2008

(51) Int. Cl. G06Q 30/00

(52) U.S. Cl. 705/23

(57) ABSTRACT

A point of sale system including a point of sale register and a processor operatively coupled to the point of sale register, wherein the processor is physically discreet from the point of sale register. The system further includes a scanner operatively coupled to the processor. The scanner is configured to scan and capture data such that the processor and the scanner provide additional functionality to the point of sale register.

The present invention is directed to a point-of-sale system, and more particularly, to a point-of-sale enhancement system for adding additional functionality to an existing point-of-sale system.

### BACKGROUND

Point-of-sale systems are widely used by various retailers, such as supermarkets, restaurants, hotels, gas stations, convenience stores and the like to perform basic accounting and inventory functions. The point-of-sale systems can take a variety of forms, such as cashier-operated checkout systems (i.e. registers, cash registers, electronic cash registers), self-checkout systems, and other similar transaction-enabling and transaction-tracking devices. These point-of-sale systems can be manufactured and sold by a variety of companies, such as International Business Machines Corp. (IBM), NCR Corporation, Panasonic and others.

Existing point-of-sale systems may have a predetermined functionality. In order to change or upgrade the functionality of the point-of-sale system, the internal processing unit/operating system/software of the point-of-sale system must often be accessed and modified. However, it can be difficult for the owner/operator of a point-of-sale system to make such modifications. Accordingly, the owner/operator must often seek assistance from the manufacturer, or from an authorized dealer, to make the desired modifications, which can be expensive and time consuming. In addition, modifications can be complicated due to the fact that many owners/operators have point-of-sale systems made by multiple manufacturers, or have varying models with differing functionalities.

### SUMMARY

Accordingly, the present invention is directed to a system wherein an existing point-of-sale system can be upgraded without having to access the internal processing unit/operating system/software of the point-of-sale system. More particularly, in one embodiment the invention is a point of sale system including a point of sale register and a processor operatively coupled to the point of sale register, wherein the processor is physically discreet from the point of sale register. The system further includes a scanner operatively coupled to the processor. The scanner is configured to scan and capture data such that the processor and the scanner provide additional functionality to the point of sale register.

In another embodiment, the present invention is a point of sale system including a point of sale register, the point of sale register having an internal processor and utilizing internal signals to aid in transaction processing. The system further includes a processor that is physically separate and discrete from said internal processor, and a connector coupling the processor to the point of sale register. The connector is configured to forward the internal signals to the processor. The processor and connector are configured to together send emulating signals to the point of sale register, wherein each emulating signal emulates one of the internal signals.

### BRIEF DESCRIPTION OF THE DRAWINGS

FIG. 1 is a schematic representation of one embodiment of the present invention;

FIG. 2 is a schematic representation of another embodiment of the present invention;

FIG. 3 is a schematic representation of another embodiment of the present invention;

FIG. 4 is a schematic representation of another embodiment of the present invention; and

FIG. 5 illustrates one embodiment of the GS1 DataBar.

### DETAILED DESCRIPTION

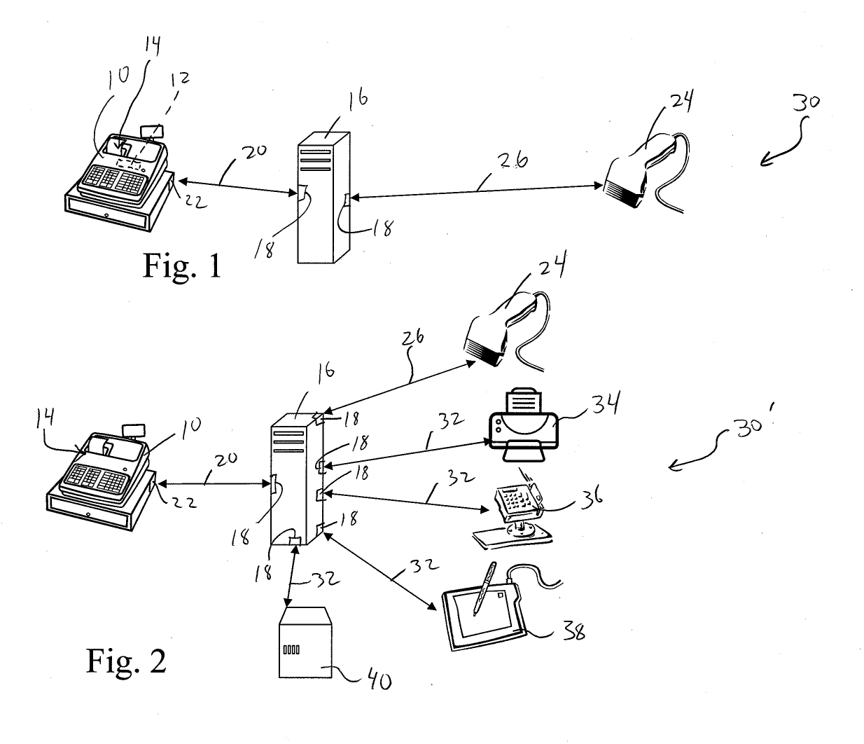

As shown in FIG. 1, in one embodiment a point-of-sale system/terminal 10 is provided. The point-of-sale system 10 can be a cashier-operated checkout system, (i.e. a register, cash register, electronic cash register, etc.), a self-checkout system, or any other similar transaction-enabling or transaction-tracking device. The point-of-sale system 10 may have the ability to record transactions, calculate taxes, store cash and other legal tender, calculate total purchase amounts, provide receipts, etc.

The point-of-sale system 10 may include an internal/integrated CPU/controller/processor 12 (collectively termed a “processor” herein), and may also include an integrated point-of-sale printer 14. For example, the point-of-sale printer 14 may be a receipt printer configured to print receipts on roll paper or the like in the well known manner. The point-of-sale system 10 may be electronically coupled to other point-of-sale systems 10 in the same store (or elsewhere), and may be electronically coupled to other associated components of the store/retail establishment in order to allow the transfer of data between such components.

The point-of-sale system 10 may be coupled to a CPU/controller/processor 16 (collectively termed a “processor” herein). The processor 16 can be physically separate and discrete from the point-of-sale system 10 and its processor 12. For example, the point-of-sale system 10 may include an outer casing/housing, and the processor 16 may have its own associated casing/housing that is separate and discrete from that of the point-of-sale system 10. The processor 16 may be separate and apart from, and operate independently of, the processor of the point-of-sale system 10. For example, the processor 16 can be a stand alone “box” or tower that is separate from, and separately moveable relative to the point-of-sale system 10.

The processor 16 may have various ports 18 for coupling the processor 16 to various other components/peripherals or the like. For example, in one embodiment, one end of a connecting component or cable 20 is removably plugged into a port 18 of the processor 16, and the other end of the connecting cable 20 is removably plugged into a port (such as a serial port) 22 of the point-of-sale system 10. The cable 20 provides bi-directional communication between the point-of-sale system 10 and the processor 16. Alternately, a wireless connection may be provided in place of the cable 20.

Because the point-of-sale system 10 can be made by various manufacturers and have various differing operating characteristics, the cable/connecting component 20 must be selected to match the characteristics of the point-of-sale system 10. For example, the port 22 of the point-of-sale system 10 may have a certain physical shape, and thus the plug or associated end of the cable 20 must be correspondingly shaped to be received in the port 22. Moreover, the processor/operating system/software of the point-of-sale system 10 can differ across various manufacturers/models, and therefore the cable/connecting component 20 must be selected to appropriately interface with the processor/operating system/software. The cable 20 may be a POS input/output communication cable which allows communications between the processor 16 and point-of-sale 10 in assembly language.

In particular, the cable 20 may echo internal signals of the point-of-sale system 10 for the benefit of the processor 16. For example, when the operator of the point-of-sale system 10 makes a keystroke on the keypad or keyboard, or scans an item (with an existing/connected scanner), or swipes a card to read a magnetic strip (with an existing/connected card reader), etc. a set of signals (i.e. electrical signals) is generated and transmitted in the point-of-sale system 10. These signals can also be generated internally by the point-of-sale system 10 (i.e. when print instructions are sent, or a reward is triggered, or a UPC lookup table is referenced, etc.). The cable 20 listens to, and echoes/reproduces/forwards these signals to the processor 16.

The cable 20 and/or processor 16 may be configured/programmed to translate/understand the signals utilized by the point-of-sale system 10, and/or its associated internal processor 12. For example, the cable 20 and/or processor 16 may be able to translate/understand that a certain set of signals utilized by the point-of-sale system 10 means that a certain keystroke was made, or a particular item was scanned, or a card was read/swiped, etc. In this manner the processor 16 can “listen in” to all activities of, and signals sent within, the point-of-sale system 10. The processor 16 can then take note of and/or record the signals such that the processor 16 is fully informed as to the status of the point-of-sale system 10, as well as the functions being carried out the by the point-of-sale system 10.

The cable 20 and/or processor 16 may also be configured to send signals to the point-of-sale system 10 for processing thereby. The signals sent by the cable 20/processor 16 may simulate/emulate signals that are internal to, or utilized by, the point-of-sale system 10. For example, if the processor 16 desires to cause the point-of-sale system 10 to calculate a total during a purchase transaction, the processor 16/cable 20 can send a signal to the point-of-sale system 10. That signal sent by the processor 16/cable 20 is identical to, or simulates, the internal signal utilized in the point-of-sale system 10 when the “Total” button on the keyboard of the point-of-sale system 10 is pressed by the operator. The point-of-sale system 10 can calculates the total, and the output is in the form of a signal (i.e. sent to the output screen) which can be read by the cable 20 and forwarded to the processor 16.

The point-of-sale system 10 may be unable to distinguish internally generated signals from those signals sent by the processor 16. All, or nearly all, of the functions/signals of the point-of-sale system 10 may be able to be monitored and/or reproduced/emulated by the processor 16/cable 20. In this manner, the processor 16 can seamlessly monitor, and control, the point-of-sale system 10 without having to access or compromise the internal processor/operating system/code/software of the point-of-sale system 10. Since the signals that the cable 20 listens to, and sends, may be electrical signals, the cable 20 may essentially be considered a piece of hardware with embedded circuitry.

As shown in FIG. 1, a scanner 24 may be coupled to the processor. The scanner 24 may be permanently or removably coupled to the processor 16 by a cable 26 or other connection. The scanner 24 may thus be directly operatively coupled to the processor 16 by the cable 26, but indirectly (and not directly) operatively coupled to the point-of-sale system 10. FIG. 1 schematically illustrates the scanner 24 as a hand-held, and hand-manipulable, scanner. However, it should be understood that the scanner 24 could also take the form of a permanently mounted scanner which is embedded in a work surface (i.e. embedded in checkout counter or the like), or could take various other forms, such as a reader or sensor. However, the term “scanner” as used herein includes all of these components

The scanner 24 may be configured to scan and capture data in two dimensions (or one dimension, if desired), such as barcode data using two-dimensional barcodes. For example, many existing barcode readers/scanners only scan linearly or in a single dimension, to capture a one-dimensional/directional or linear pattern of bars and spaces in the manner of use of common barcodes. Many existing barcode scanner may be termed “omnidirectional” scanners; however, such scanners typically can only scan linearly, but can do so when the scanner is oriented at various angles to the barcode being scanned. However, the scanner 24 used herein may be able to recognize image data, optically recognize text data, colors or the like in patterns of more than one dimension, such as optical images, drawings, pictures, two-dimensional patterns, two-dimensional symbols etc.

The scanner 24 can provide a significant upgrade over existing barcode scanners that may be coupled to a point-of-sale system. For example, the retail industry is migrating from, and indeed will soon be phasing out, existing one-dimensional linear barcodes and replacing them with the GS1 DataBar™ (previously termed “reduced space symbology” (RSS)). The DataBar will be used on retail goods and coupons, and various other settings. As shown in FIG. 5, The DataBar 25 may have two components: a liner barcode portion 27 and a symbolic portion 29. The symbolic portion 29 of the DataBar 25 can present data in a two-dimensional matrix format that may have a plurality of spaces/squares in a “checkerboard” manner which is not capable of being read by existing one-dimensional barcode scanners. However, the use of the processor 16/scanner 24 provides an instant upgrade to existing point-of-sale systems 10, and provides the ability to process the new DataBar symbols 29.

When a symbol portion 29 of a DataBar 25 is scanned and recognized by the scanner 24, the scanner 24 may forward the captured data to the processor 16 for further processing. The processor 16 may then analyze the captured data to extract other forms of data from the symbol portion 29, such as the manufacturer of the retail item, identification of the product, coupon family codes, coupon value codes, etc. This information can then be edited and/or forwarded to the point-of-sale system 10 in a format compatible with, and readable by, the point-of-sale system 10. The point-of-sale system 10 can then process the data, complete the transaction and update applicable records, forward data to other point-of-sale register systems, etc.

Accordingly, the use of the processor 16 and scanner 24 of FIG. 1 provides an instant upgrade to the point-of-sale system 10, thereby allowing an existing point-of-sale system 10 to read and process DataBars symbol portions 29 and avoid obsolescence. Moreover, because the processor 16 plugs directly into the existing point-of-sale system 10, the internal processor/operating system/code/software of the point-sale-system 10 does not need to be accessed or modified. It can be expensive and time consuming to obtain the appropriate authorization and licenses from the manufacturer of the associated point-of-sale system in order to access or modify those systems. In some cases, a representative or authorized dealer of the manufacturer/seller of the point-of-sale system 10 must be hired to modify the point-of-sale system 10. Thus, extensive and time consuming modifications can be avoided by use of the processor 16 and scanner 24 of the present invention.

In addition, the functionality of the scanner 24, and the ability to provide its processed output to the point-of-sale system/register 10, can be used in a variety of other manners. For example, the scanner 24 may have the capability to scan paper coupons in their entirety, and forward the image to the processor 16. The processor 16 can then verify the coupon as genuine and forward instructions to the point-of-sale system 10 relating to the appropriate action to be taken (i.e. providing a discount, rebate or the like).

Moreover, besides paper coupons, coupons in various other formats, such as electronically displayed coupons, can be scanned and processed by the system 30 of FIG. 1. For example, in one embodiment, a coupon or gift “card” may be transmitted to a wireless device, such as a mobile phone or cell phone. The user of the mobile phone may then display the coupon on the display screen of the mobile phone, and the scanner 24 then can scan and capture the coupon image data. The appropriate information is then forwarded from the processor 16 and to the point-of-sale system 10.

The system 30 can also aid in electronic coupon processing. More particularly, since the coupon and/or its associated barcodes can be captured as images by the scanner 24, the associated information can then be electronically forwarded to a manufacturer and/or coupon clearinghouse for the processing. The system 30 can also be used to provide for electronic benefits transfer in a similar manner. The processor 16 can also provide various functions, such as communicate with store Wi-Fi or ethernet services, capture an audit trail of processed data, and capture and store transaction information. The system 30 also allows manufacturers to upgrade the existing point-of-sale systems to add the capability of processing coupons. For example, some retailers (such as drycleaners, hardware stores, etc.) do not have the capability to accept particular coupons (such as manufacturer's coupons or the like). The use of the system 30 of the present inventor provides for an instant upgrade in that area.

The processor 16 may be configured to operate substantially independently of the point-of-sale system 10. In particular, the processor 16 may remain discrete and non-integrated with the software/operating system/code/processor 12 of the point-of-sale system to a significant extent to prevent interference with the operations of the point-of-sale system 10. Keeping the processor 16 discrete from those of the point-of-sale system 10 also helps to avoid overburdening, slowing down, or interfering with of the operations of the point-of-sale system 10. The processor 16 may have a power source that is separate and discrete from that of the point-of-sale system 10, and may have its own source code.

As shown in FIG. 2, various other peripherals can be connected to the processor 18 by cables or connecting components 32, or wireless connections, to provide the system 30′ shown therein. For example, a printer 34, magnetic card reader 36, an electronic signature pad 38, and component 40 can be connected to the processor 16. Component 40 designates a generic component/peripheral which can take the form of, but is not limited to, RFID tag readers, personal identification devices (i.e. fingerprint scanners, retinal scanners, or other biometric devices), cash handling devices (i.e. devices for receiving and dispensing cash), etc. Each peripheral device 34, 36, 38, 40 may include a port for connecting to the associated cable 32, or may have a permanently attached cable or connecting component 32. The processor 16 may be physically separate and apart from, and operate independently of, each of the peripheral devices 24, 34, 36, 38, 40 in the same manner that the processor 16 is separate and discrete from the point-of-sale system 10 as described above.

These peripherals 34, 36, 38, 40 provide additional functionality to the existing point-of-sale system 10. For example, the printer 34 can be used to print various advertisements, rebate forms, coupons, instant rewards or the like. The printer 34 may be able to print at a higher quality, on larger sheets, or in color, or have various other improvements over the printer 14 in existing point-of-sale systems 10. The magnetic card reader 36 may be able to read a magnetic code on a credit card, debit card, gift card, etc., and have an integrated keypad or signature pad. The electronic signature pad 38 may be able to be written upon by a user to verify a transaction and may be coupled to or be part of, the magnetic card reader 36. A RFID tag reader can read radio frequency identification tags embedded in products, labels or the like can provide the associated benefits for tracking RFID tags relating to inventory tracking, theft detection, etc.

The peripherals 34, 36, 38, 40 and processor 16 provide a quick and easy manner to upgrade the point-of-sale system 10 to operate in conjunction with the peripherals 34, 36, 38, 40, as designed. In addition, the processor 16 can be programmed to utilize the various peripherals 24, 34, 36, 38, 40 in various other manners. For example, the processor 16 may be programmed to offer double coupon rewards for coupons scanned by the optical scanner 24, offer double coupon rewards for only selected products or coupons, accept coupons that lack a barcode, provide instant rebates, provide random rewards to certain customers, print targeted messages to particular customers utilizing the printer 34, utilize its own reward cards etc. The processor 16 may also be able to connect to the internet and enable web services, and aggregate data from various sources.

It should be noted that the peripherals 24, 34, 36, 38, 40 described herein may differ from many existing peripherals which are directly coupled to an existing point-of-sale system. Instead, in the present invention, the peripheral 24, 34, 36, 38, 40 are connected to the processor 16, which is in turn connected to the point-of-sale system (i.e. via its port 22). Thus, in this case, the processor 16 can act as a conduit or “translator” between each peripheral 24, 34, 36, 38, 40 and the point-of-sale system 10. This arrangement avoids having to customize each peripheral 23, 34, 36, 38, 40 and/or the point-of-sale system to allow communication between those systems; instead a single interface is provided by the processor 16, and additional peripherals 24, 34, 36, 38, 40 can be easily added and their use/output customized as desired.

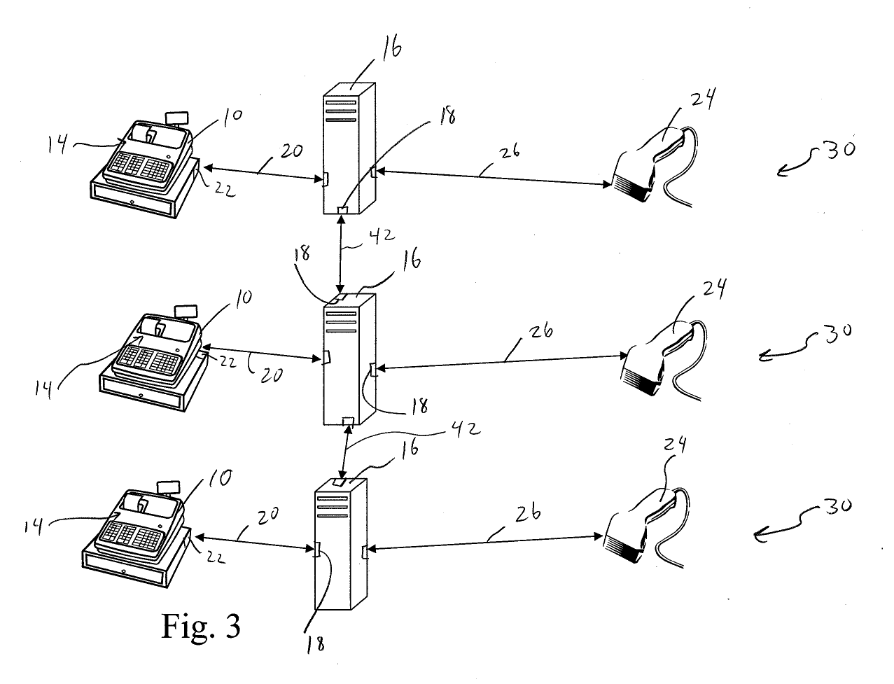

As shown in FIG. 3, a plurality of systems 30 in FIG. 1 can be provided and connected together. For example, in this case, each system 30 can represent a point-of-sale location in a single store. Each system 30 can be connected together as indicated by connectors 42. The connectors 42 can consist of various technologies such as hard wiring (i.e. ethernet) or wireless technology (i.e. Wi-Fi). Although FIG. 3 illustrates three basic systems 30 of FIG. 1 connected together, each system 30 may also include one or more of the peripherals 34, 36, 38, 40.

Each of the systems 30 may have the same functionality as the other systems 30. For example, in the case of grocery store, a plurality of checkout stations in the form of functionally identical systems 30 may be provided and connected together. Alternately, the various systems/transaction locations 30 may have different functionalities. For example, continuing with the example of a grocery store, some of the systems/transaction locations 30 may be located in the meat department and associated with, for example, the weighing and purchase of sliced meats. Other transaction locations/systems 30 may be located in the video rental portion of the store to assist in such rental transactions. Other transaction locations/systems 30 could be located in the pharmacy section of a store, etc. In this manner, each of the systems 30 can utilize the upgrade capabilities provided by the scanner 24 and/or associated peripherals 34, 36, 38, 40, and still be connected to the processors 16 and/or the central server of the store. Each store/retailer may be able to then communicate its information within its store, or to other stores, for further processing.

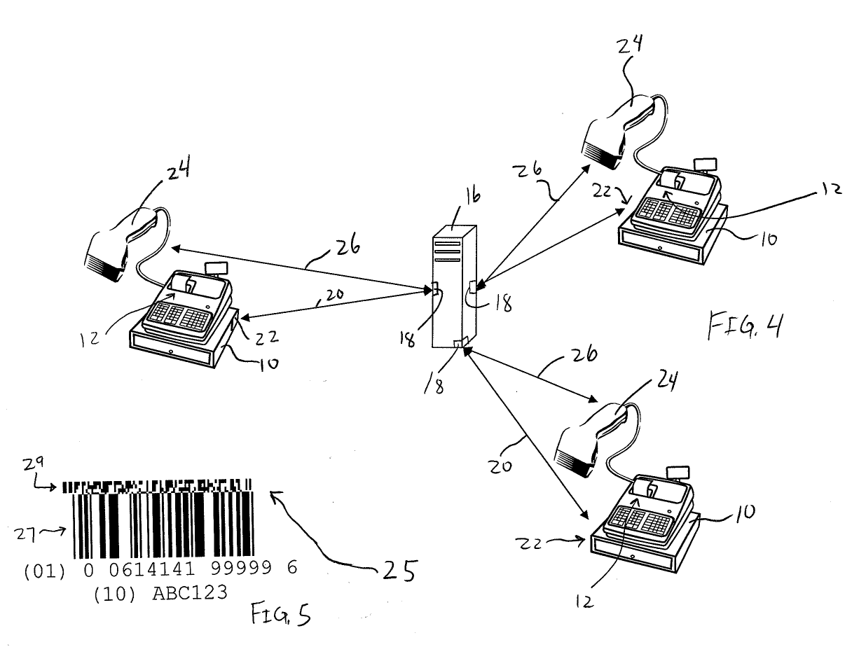

In another alternate embodiment, as shown in FIG. 4, multiple point-of-sale systems 10 and associated peripherals are provided. In this case, however, each point-of-sale system 10 (and its associated scanner 24 and/or other peripherals) is connected to, and supported/driven by, a single processor 16. Each of the systems 10 may have various different peripherals (not shown) to support the specific needs at each transaction location.

An “upgrade” kit may be marketed and sold to owners/operators of existing point-of-sale systems 10. The upgrade kit can consist of at least the processor 10, cable or connector 20, and scanner 24 (and/or other peripherals 34, 36, 38, 40). These three basic components can be connected together, and to an existing point-of-sale system 10 as described herein, to provide instant upgrade capabilities with the various benefits as described above. The cable 20 included in the kit may be specifically configured to interact with a particular point-of-sale system 10. In this manner each kit can be tailored to the individual needs of each purchaser of the kit.

Having described the invention in detail and by reference to the preferred embodiments, it will be apparent that modifications and variations thereof are possible without departing from the scope of the invention.

What is claimed is:

1. A point of sale system comprising:
a point of sale register;
a processor operatively coupled to said point of sale register, wherein said processor is physically discreet from said point of sale register; and
a scanner operatively coupled to said processor, wherein said scanner is configured to scan and capture data such that said processor and said scanner provide additional functionality to said point of sale register.

2. The system of claim 1 wherein said scanner is configured to scan and capture data in two dimensions

3. The system of claim 1 wherein said point of sale register includes an internal processor and is configured to track the purchase of various items, calculate a total purchase price, and aid an operator in completing the sale of said various items to a customer, wherein said internal processor is separate and discreet from said processor.

4. The system of claim 1 wherein said processor is operatively coupled to said point of sale register by a connecting cable.

5. The system of claim 4 wherein said connecting cable is releasably connectable to a port of said point of sale register.

6. The system of claim 4 wherein said connecting cable and said processor are together configured to provide signals to said point of sale register which emulate internal signals utilized by said point of sale register.

7. The system of claim 4 wherein said connecting cable is configured to forward to said processor internal signals utilized by said point of sale register.

8. The system of claim 1 wherein said scanner is directly operatively coupled to said processor, and is not directly operatively coupled to said point of sale register.

9. The system of claim 1 wherein said scanner is configured to forward said captured data to said processor for further processing by said processor.

10. The system of claim 1 further comprising a supplemental point of sale register operatively coupled to said processor, and wherein the system further includes a supplemental scanner operatively coupled to said processor and associated with said supplemental point of sale register.

11. The system of claim 1 wherein said scanner is configured to scan and capture data in DataBar format under GS1 US standards.

12. The system of claim 1 wherein said processor is configured to run substantially independently of any operations of said point of sale register to minimize any interaction with operation of said point of sale register.

13. The system of claim 1 wherein said scanner is configured to scan and capture data, in two dimensions, that is provided in a two-dimensional matrix.

14. A method for operating a point of sale system comprising:
accessing a point of sale system including a point of sale register, a processor operatively coupled to said point of sale register, wherein said processor is physically discreet from said point of sale register, and a scanner operatively coupled to said processor;
utilizing said scanner to scan and capture data; and
providing, from said scanner to said processor, output data of said scanner related to said scanned and captured data such that said processor and scanner provide additional functionality to said point of sale register.

15. The method of claim 14 wherein the scanned and captured data is presented in two dimensions, and is two dimensionally scanned and captured.

16. The method of claim 14 wherein said point of sale register has an internal processor and utilizes internal signals to aid in transaction processing, and said internal signals are forwarded to said processor, and wherein said processor and cable together send emulating signals to said point of sale register, wherein each emulating signals emulates one of said internal signals.

17-21. (canceled)

22. A point of sale system comprising:
a point of sale register, said point of sale register having an internal processor and being configured to utilize internal signals to aid in transaction processing;
a processor that is physically separate and discrete from said internal processor; and
a connector coupling said processor and said point of sale register, wherein said connector is configured to forward said internal signals to said processor, and wherein said processor and connector are configured to together send emulating signals to said point of sale register, wherein each emulating signal emulates one of said internal signals utilized by said point of sale register.

23. The system of claim 22 wherein said internal signals and said emulated signals are indistinguishable by said internal processor.

24. A method for operating a point of sale system comprising:
accessing a point of sale system including a point of sale register, said point of sale register having an internal processor, the system further including a processor that is physically separate and discrete from said internal processor and a connector coupling said processor and said point of sale register;
operating said point of sale register such that said point of sale register generates internal signals to aid in the processing of a transaction;
forwarding, by said connector, said internal signals to said processor; and
sending, by said processor and connector, emulating signals to said point of sale register, wherein each emulating signal emulates one of said internal signals utilized by said point of sale register.

25. A system configured to connect to a point of sale register having an internal processor and configured to utilize internal signals to aid in transaction processing, the system comprising:
a processor; and
a connector configured to couple said processor to said point of sale register, wherein said connector is configured to forward said internal signals to said processor, and wherein said processor and connector are configured to together send emulating signals to said point of sale register, wherein each emulating signal emulates one of said internal signals utilized by said point of sale register.

26. A method for upgrading a point of sale register comprising:
accessing an existing point of sale register having an internal processor and configured to utilize internal signals to aid in transaction processing; and
operatively connecting a processor that is physically separate and discrete from said internal processor to said point of sale register such that said processor receives internal signals of said processor, and such that said processor sends emulating signals to said point of sale register, wherein each emulating signal emulates one of said internal signals utilized by said point of sale register.
